(19) United States
(12) Patent Application Publication
(10) Pub. No.: US 2008/0062048 A1
(43) Pub. Date: Mar. 13, 2008

(54) Chip antenna module

(76) Inventors: Cho-Kang Hsu, Hsinchu (TW); Chih-Ming Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/518,239

(22) Filed: Sep. 11, 2006

(51) Int. Cl. H01Q 1/24

(52) U.S. Cl. 343/702; 343/700 MS; 343/895

(57) ABSTRACT

A chip antenna module with two loops is disposed on a ceramic housing for receiving two different frequencies, and an adjustable matching loop is disposed on the housing for shortening the development time of the antenna module by means of adjusting the adjustable matching loop. The chip antenna module comprises a ceramic housing, a first loop, a second loop, and a matching loop. The first loop is disposed on a top surface of the housing for receiving a first frequency, the second loop is disposed on a top surface of the housing for receiving a second frequency, and the matching loop is disposed on a bottom surface of the housing for adjusting a matching impedance. In order to satisfy the system requirements of the matching impedance, a user can simply adjust the path of the matching loop via the special loop design of the matching loop.

### BACKGROUND OF THE INVENTION

1. Field of the invention

The present invention relates to a chip antenna module, and more particularly to a dual-frequency loop antenna, and an easy adjustable matching loop thereon.

2. Description of the Prior Art

Wireless communication techniques have been developing rapidly in recent years, and wireless communication products have been increasing in number to the point where it seems nearly everyone has a cell phone. Furthermore, single-frequency and dual-frequency cell phone transmission have developed to triple-frequency and four-frequency, known as common frequency types (850 MHz, 900 MHz, 1800 MHz, and 1900 MHz.)

The characteristics most in demand from consumers are that their wireless communication products are small in size, lightweight, easy to use, and have good reception. For this reason, the antennas of wireless communication products have been improved in various ways by manufacturers in recent years. Antennas for wireless communication products are either exterior antennas or interior antennas. Exterior antennas are antennas that are exposed to the housing of the wireless communication product, however, interior antennas are antennas that are panel antennas disposed on the housing and are then installed together within the wireless communication products for receiving signals.

For example, the antenna of a dual-frequency cell phone usually has two loops disposed thereon; one loop for receiving a 900 MHz signal, and the other for receiving a 1800 MHz signal. However, due to the large size of antennas of conventional dual-frequency cell phones the lack of a fine-tuning function, the development time for antennas according to different systems is longer.

In addition, there is also a difference in reception between antennas that have a printed circuit board with a ground layer or ones without a printed circuit board. Furthermore, the development time of the antenna according to different environments is longer.

The inventor of the present invention recognizes the above shortage should be corrected and special effort has been paid to research this field. The present invention is presented with reasonable design and good effect to resolve the above problems.

### SUMMARY OF THE INVENTION

It is a primary object of the present invention to provide a chip antenna module, wherein two loops are disposed on a housing made of a ceramic material for receiving two different kinds of frequencies and reducing the size of the antenna.

It is another object of the present invention to provide a chip antenna module, wherein two loops are disposed on a housing made of a ceramic material for receiving two different kinds of frequencies; and an adjustable matching loop is disposed on the housing for shortening the development time of the antenna module by means of the adjustable matching loop which is adjusted when using different kinds of systems.

It is another object of the present invention to provide a chip antenna module, wherein two loops are disposed on a housing made of a ceramic material for receiving two different kinds of frequencies; and an adjustable matching loop is disposed on the housing for shortening the development time of the antenna module by means of the adjustable matching loop being adjusted when using a printed circuit board with a ground layer or without a printed circuit board.

It is another object of the present invention to provide a chip antenna module, wherein two loops are disposed on a housing made of a ceramic material for receiving two different kinds of frequencies; and an adjustable matching loop is disposed on the housing for shortening the development time of the antenna module by means of simple adjustment of the adjustable matching loop.

For achieving these objectives stated above, the chip antenna module of the present invention comprises a housing made of a ceramic material, a first loop, a second loop, and a matching loop. The first loop is disposed on a top surface of the housing for receiving a first frequency, the second loop is disposed on a top surface of the housing for receiving a second frequency, and the matching loop is disposed on a bottom surface of the housing for adjusting a matching impedance. In order to satisfy the system requirements of the matching impedance, the designers are able to simply adjust the path of the matching loop via the special loop design of the matching loop.

Furthermore, the matching loop is formed using two mutually interlaced loops or two mutually annular surrounded loops. When the chip antenna module is applied to different kinds of systems or environments, by means of the path of the matching loop, it is linked at a suitable position for adjusting the impedance of the chip antenna module so as to provide good reception.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a schematic view according to a first embodiment of the present invention;

FIG. 2 is a schematic view for adjusting impedance of a matching loop according to the first embodiment;

FIG. 3 is a schematic view according to a second embodiment of the present invention;

FIG. 4 is a schematic view for adjusting impedance of a matching loop according to the second embodiment;

FIG. 5 is a schematic view showing the chip antenna module when applied to a printed circuit board with a ground layer of the present invention; and

FIG. 6 is a schematic view showing the chip antenna module when applied, without a printed circuit board of the present invention.

The drawings will be described further in connection with the following detailed description of the invention.

### DETAILED DESCRIPTION OF THE PREFERRED EMBODIMENTS

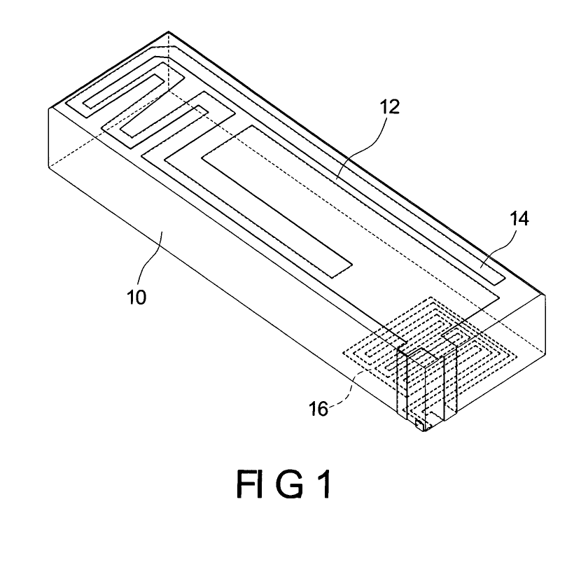

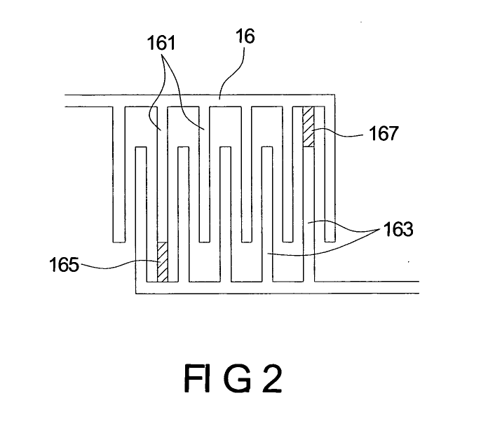

Reference is made to FIG. 1, which is a schematic view according to a first embodiment of the present invention. A chip antenna of the present invention comprises a housing 10 made of a ceramic material, a first loop 12, a second loop 14, and a matching loop 16. The first loop 12 is disposed on a top surface of the housing 10 for receiving a first frequency, the second loop 14 is disposed on a top surface of the housing 10 for receiving a second frequency, and the matching loop 16, disposed on a bottom surface of the housing 10, is formed by two mutually interlaced loops (shown in FIG. 2) for adjusting a matching impedance.

The first loop 12, the second loop 14, and the matching loop 16, made of silver or nickel, are disposed on the housing 10 via thick-film technology. The second frequency such as 900 MHz is received by the second loop 14 is less than the first frequency such as 1,800 MHz is received by the first loop 12, and the first loop 12 is surrounded by the second loop 14.

When the chip antenna module is applied to different kinds of systems, by means of the impedance of the adjustable matching loop 16 it is easily adjusted (as shown in FIG. 2) for shortening the development time of the antenna module. The matching loop 16 is formed by a plurality of mutually interlaced loops 161, 163. When the chip antenna module is applied to different kinds of systems or environments with or without the printed circuit board, by means of the path of the matching loop 16 it is linked at a suitable position such as at least two loops 165, 167 as shown in FIG. 2 for adjusting the impedance of the chip antenna module so as to provide good reception.

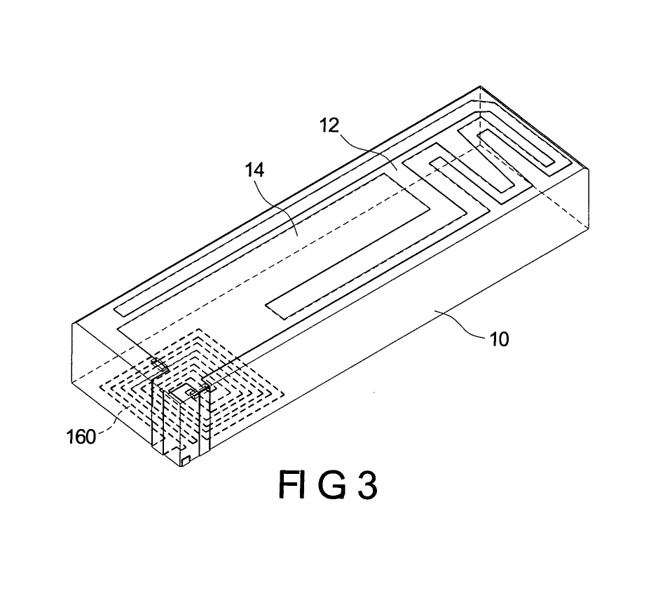

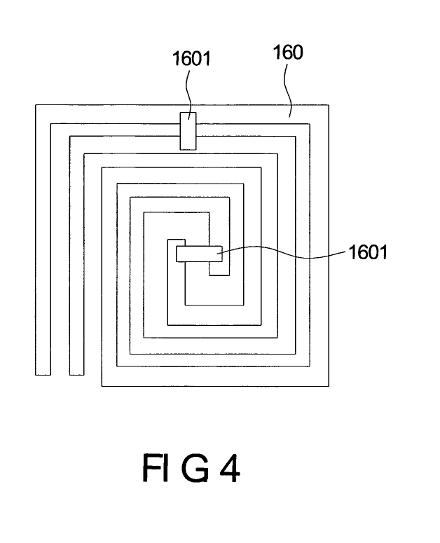

Reference is made to FIG. 3, which is a schematic view according to a second embodiment of the present invention. A chip antenna of the present invention comprises a housing 10 made of a ceramic material, a first loop 12, a second loop 14, and a matching loop 160. The first loop 12 is disposed on a top surface of the housing 10 for receiving a first frequency, the second loop 14 is disposed on a top surface of the housing 10 for receiving a second frequency, and the matching loop 160, disposed on a bottom surface of the housing 10, is formed by two mutually annular surrounded loops (shown in FIG. 4) for adjusting a matching impedance. The difference between the first embodiment and the second embodiment is the structural design of the matching loop 16 and the matching loop 160, but the rest is the same.

When the chip antenna module is applied to different kinds of systems, by means of the impedance of the adjustable matching loop 160 it is easily adjusted (as shown in FIG. 4) for shortening the development time of the antenna module. The matching loop 160 is formed by a plurality of mutually annular surrounded loops. When the chip antenna module is applied to different kinds of systems or environments with or without the printed circuit board, by means of the path of the matching loop 160 it is linked at the suitable position such as a loop 1601 as shown in FIG. 4 for adjusting the impedance of the chip antenna module so as to provide good reception.

The above stated embodiments are for the purpose of explanation only, and various loop designs of the matching loop 16 can be linked at suitable positions for simply adjusting the impedance of the antenna.

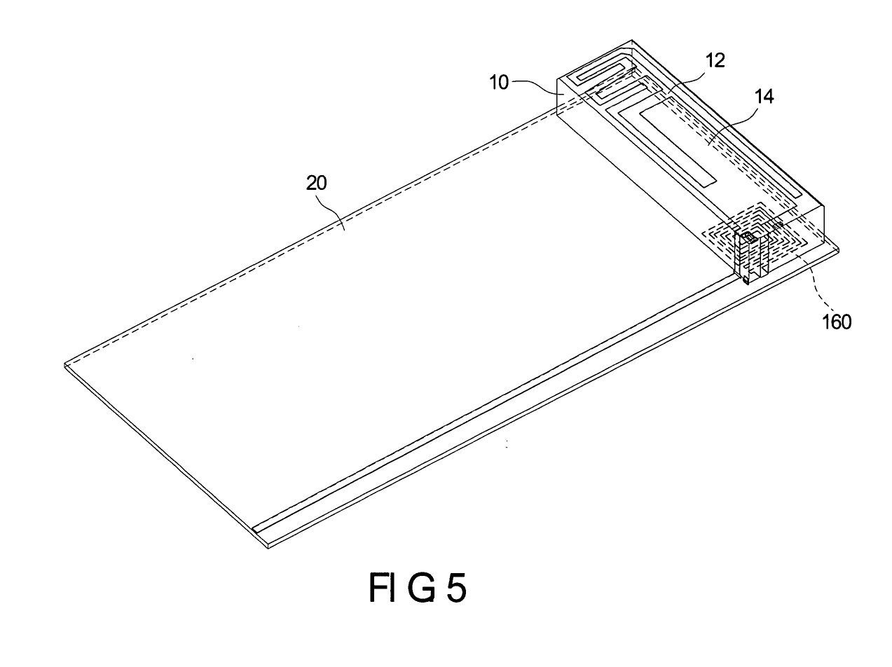

FIG. 5 is a schematic view showing the chip antenna module applied to a printed circuit board with a ground layer of the present invention. By means of the impedance of the matching loop 160 it is adjusted as shown in FIG. 2 and FIG. 4 for improving the influence of a receiving signal via a ground layer (not shown) of the printed circuit board 20 so as to provide good reception.

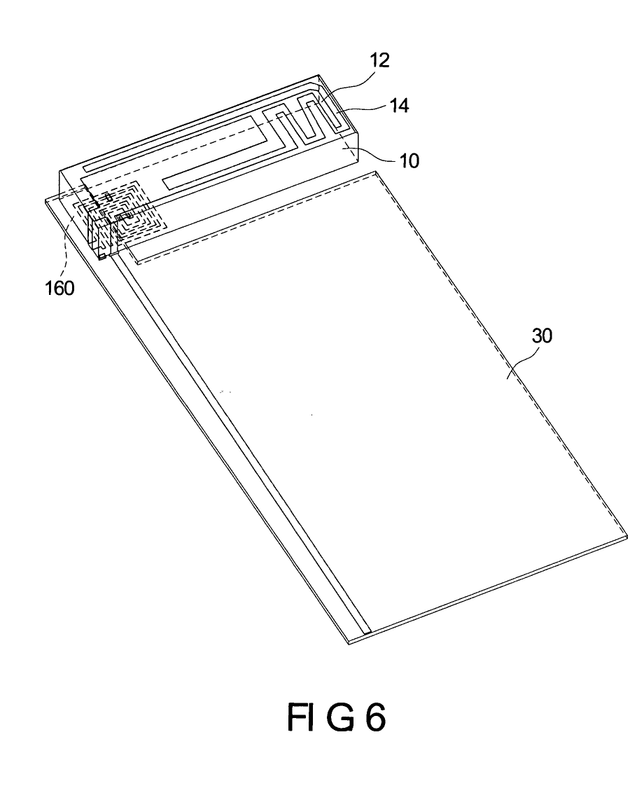

FIG. 6 is a schematic view showing the chip antenna module without a printed circuit board of the present invention. By means of the impedance of the matching loop 160 it is adjusted as shown in FIG. 2 and FIG. 4 to provide good reception.

The chip antenna module of the present invention has the following features:

1. The chip antenna module of the present invention is able to receive two different kinds of frequencies and reduces the size of the antenna.

2. The adjustable matching loop is disposed on the housing and is made of a ceramic material. When the chip antenna module is applied to different kinds of systems, by means of the impedance of the adjustable matching loop it is easily adjusted for shortening the development time of the antenna module.

3. The chip antenna module can be applied to different kinds of systems with or without the printed circuit board to adjust the impedance of the matching loop.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A chip antenna module, comprising:
a housing made of a ceramic material;
a first loop is disposed on a top surface of the housing for receiving a first frequency;
a second loop is disposed on a top surface of the housing for receiving a second frequency; and
a matching loop is disposed on a bottom surface of the housing for adjusting a matching impedance.

2. A chip antenna module as in claim 1, wherein the matching loop is formed by two mutually interlaced loops.

3. A chip antenna module as in claim 1, wherein the matching loop is formed by two mutually annular surrounded loops.

4. A chip antenna module as in claim 1, wherein the first loop is disposed on the housing via thick-film technology.

5. A chip antenna module as in claim 1, wherein the second loop is disposed on the housing via thick-film technology.

6. A chip antenna module as in claim 1, wherein the matching loop is disposed on the housing via thick-film technology.

7. A chip antenna module as in claim 1, wherein the first loop, the second loop, and the matching loop are made of silver or nickel.

8. A chip antenna module as in claim 1, wherein the first loop is surrounded by the second loop.

9. A chip antenna module as in claim 1, wherein the second frequency is received by the second loop is less than the first frequency is received by the first loop.

10. A chip antenna module, comprising:
a housing made of a ceramic material;
a first loop is disposed on a top surface of the housing for receiving a first frequency; and
a second loop is disposed on a top surface of the housing for receiving a second frequency.

11. A chip antenna module as in claim 10, wherein the first loop is disposed on the housing via thick-film technology.

12. A chip antenna module as in claim 10, wherein the second loop is disposed on the housing via thick-film technology.

13. A chip antenna module as in claim 10, wherein the first loop and the second loop are made of silver or nickel.

14. A chip antenna module as in claim 10, wherein the first loop is surrounded by the second loop.

15. A chip antenna module as in claim 10, wherein the second frequency received by the second loop is less than the first frequency received by the first loop.
